(19) United States
(12) Patent Application Publication
(10) Pub. No.: US 2026/0032427 A1
(43) Pub. Date: Jan. 29, 2026

(54) CAPABILITY REPORTING FOR MULTI-MODEL ARTIFICIAL INTELLIGENCE/MACHINE LEARNING USER EQUIPMENT FEATURES

(71) Applicant: Nokia Technologies Oy, Espoo (FI)

(72) Inventors: Keeth Saliya Jayasinghe LADDU, Espoo (FI); Amaanat ALI, Espoo (FI); Mihai ENESCU, Espoo (FI)

(21) Appl. No.: 18/997,285

(22) PCT Filed: Aug. 25, 2023
(86) PCT No.: PCT/EP2023/073325

§ 371 Date: Jan. 21, 2025

(30) Foreign Application Priority Data
Sep. 22, 2022 (GB) 2213834.1

(51) Int. Cl. H04W 8/22; H04L 41/16; H04W 24/02

(52) U.S. Cl. CPC H04W 8/22; H04L 41/16; H04W 24/02

(57) ABSTRACT

The present invention provides apparatuses, methods, computer programs, computer program products and computer-readable media for capability reporting for multi-model AI/ML UE features. The method comprises generating user equipment capability information, including identifying at least one machine learning model available at the user equipment for a predetermined scenario, assigning a unique identification to each of the at least one machine learning model, associating the at least one machine learning model having the unique identification with at least one of a parameter list, a data set and a registration ID, and reporting the generated user equipment capability information to a network entity.

### FIELD OF THE INVENTION

Various example embodiments relate to apparatuses, methods, systems, computer programs, computer program products and computer-readable media for capability reporting for multi-model AI/ML UE features.

### Abbreviations

5G—5th Generation
gNB—5G/NR base station
NR—New Radio
RAN—Radio Access Network
AI—Artificial Intelligence
ML—Machine Learning
UE—User Equipment
UL—Uplink
DL—Downlink
DCI—Downlink Control Information
MAC CE—Medium Access Control Control Element
MIMO-Multiple—Input and Multiple-Output
NN—Neural Network
CSI—Channel State Information
SSB—Synchronization Signal Block
RS—Reference Signal
TRP—Transmission Point
Tx—Transmitter
Rx—Receiver
RB—Residual Block
CNN—Convolutional Neural Network

### BACKGROUND

Certain aspects of the present invention relate to Rel-18 Study Item (SI) on Artificial Intelligence (AI)/Machine Learning (ML) for the New Radio (NR) Air Interface (cf. 3GPP RP-213599).

The SI aims at exploring the benefits of augmenting the air interface with features enabling support of AI/ML-based algorithms for enhanced performance and/or reduced complexity/overhead. The target of such considerations is to lay the foundation for future air-interface use cases leveraging AI/ML techniques. The initial set of use cases to be covered include CSI feedback enhancement (e.g., overhead reduction, improved accuracy, prediction), beam management (e.g., beam prediction in time, and/or spatial domain for overhead and latency reduction, beam selection accuracy improvement), positioning accuracy enhancements. For those use cases, the benefits shall be evaluated (utilizing developed methodology and defined KPIs) and potential impact on the specifications shall be assessed including PHY layer aspects and protocol aspects.

One of the key expected outcomes of such considerations is that the “AI/ML approaches for the selected sub use cases need to be diverse enough to support various requirements on the gNB-UE collaboration levels”.

It must be noted that in the work item (WI) phase of “AI/ML for air interface”, additionally other use cases might also be addressed. Starting from Release 18, it is very likely that companies will propose a large variety of use cases and applications on ML in the gNB and UE. The goal is to explore the benefits of augmenting the air-interface with features enabling improved support of AI/ML-based algorithms for enhanced performance and/or reduced complexity/overhead. The enhanced performance here depends on the considered use cases and could be, e.g., improved throughput, robustness, accuracy or reliability, etc. The goal is that sufficient use cases will be considered to enable the identification of a common AI/ML framework, including functional requirements of AI/ML architecture, which could be used in subsequent projects. The study should also identify areas where AI/ML could improve the performance of air-interface functions. Specification impact will be assessed in order to improve the overall understanding of what would be required to enable AI/ML techniques for the air interface.

Generalizing the AI/ML model to cover different scenarios/configurations has been seen as a considerable challenge that RAN1 should investigate, and there are different approaches to solve that. It is highly unlikely that a single ML model will end up being necessary and sufficient for each and every deployment scenario. For example, developing a “universal” ML model for beam prediction in the spatial domain which performs well across different scenarios/configurations/set-ups/parameters may be hard as its performance should be validated against data for each and every deployment scenario.

Also, there may be higher training/inference complexities of having one universal model, and performance concerns may also arise if the model cannot work well in all scenarios.

### SUMMARY

Various example embodiments aim at addressing at least part of the above issues and/or problems and drawbacks.

It is an object of various example embodiments to provide apparatuses, methods, systems, computer programs, computer program products and computer-readable media for Capability Reporting for multi-model AI/ML UE features.

According to an aspect of various example embodiments there is provided a method for use in a user equipment, comprising:
generating user equipment capability information, including
   identifying at least one machine learning model available at the user equipment for a predetermined scenario;
   assigning a unique identification to each of the at least one machine learning model,
   associating the at least one machine learning model having the unique identification with at least one of a parameter list, a data set and a registration ID; and
reporting the generated user equipment capability information to a network entity.

According to another aspect of various example embodiments there is provided an apparatus for use in a user equipment, comprising
means for generating user equipment capability information, including
   means for identifying at least one machine learning model available at the user equipment for a predetermined scenario,
   means for assigning a unique identification to each of the at least one machine learning model,
   means for associating the at least one machine learning model having the unique identification with at least one of a parameter list, a data set and a registration ID, and
   means for reporting the generated user equipment capability information to a network entity.

According to another aspect of the present invention there is provided a computer program product comprising code means adapted to produce steps of any of the methods as described above when loaded into the memory of a computer.

According to a still further aspect of the invention there is provided a computer program product as defined above, wherein the computer program product comprises a computer-readable medium on which the software code portions are stored.

According to a still further aspect of the invention there is provided a computer program product as defined above, wherein the program is directly loadable into an internal memory of the processing device.

According to an aspect of various example embodiments there is provided a computer readable medium storing a computer program as set out above.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Further aspects and features of the present invention are set out in the dependent claims.

### BRIEF DESCRIPTION OF THE DRAWINGS

These and other objects, features, details and advantages will become more fully apparent from the following detailed description of various aspects/embodiments which is to be taken in conjunction with the appended drawings, in which:

FIG. 1 is a sequence diagram illustrating an example of a signaling procedure according to certain aspects of the present invention;

FIG. 2 is a flowchart illustrating an example of a method according to certain aspects of the present invention.

FIG. 3 is block diagram illustrating another example of an apparatus according to certain aspects of the present invention.

FIG. 4 is block diagram illustrating another example of an apparatus according to certain aspects of the present invention.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to certain aspects of the present invention, it is proposed to use multiple ML models for the same scenario (e.g., CSI compression, beam prediction, positioning, etc.), where the model can be changed depending on the situation/scenario/configuration. A scenario refers to at least one of a feature/sub-use case/use case. The above-mentioned issues can be avoided by using multiple ML models for the same scenario. Thus, it has to be specified how multiple ML models per a certain scenario can be defined in the NR framework.

When more than one model can be used/selected for the model inference at the UE side for a given scenario, the UE capability reporting (UE features) will consider the following:
the UE indicates the number of ML models (e.g., X=4, 6, 8) that UE can support for the same functionality (e.g., CSI compression with two-sided model, beam prediction in spatial domain with one-sided model, positioning estimated in NLOS scenario with one-sided model).
the UE indicates a ML model ID (a number that uniquely identifies different models supporting same functionality. e.g., IDs=1, 2, 3, 4 for X=4) and indicates the association between the ML model ID to a parameter list and/or data set and/or registration ID, wherein
   the parameter list defines the radio conditions (deployment type, applicable scenario, gNB/UE antenna configurations, clutter parameters, etc.) and/or ML specific details (reportable quantities, required/associated measurement configurations, required/associated assistance information, input/output & dimensions of the ML model) and/or restrictions/conditions (inference delay, required warm-up time, fine-tune requirements)
   the data set refers to a version of the data set, which is accessible for both the UE and network over other means (an operator-controlled server, proprietary cloud) and the network understands the model-related aspects based on the associated data set of the model ID.
   the registration ID refers to a unique version of the ML model with a unique identifier. Here, the trained models may be in an operator-controlled server or proprietary server, wherein the network may not have full access to the model. Still, details/parameters associated with the model can be known to the network by referring to the registration ID.
the UE indicates whether a model can be switched from one to another
   if switching is dynamic, the UE may further indicate any associated delay considerations for switching from one model to another.
   in one variant, model switching between certain model combinations may not be supported while in some other combinations, the switching may be supported.
the UE indicates whether a model can be disabled and the possibility of falling back into the parametric model
   if fallback is supported, any associated delay considerations for switching and parameter lists associated with the parametric model (e.g., for CSI compressions, Type I or Type II codebook-based reporting may consider as parametric model) may also be indicated by the UE.
the UE indicates whether more than one model can be activated at a given time.
   If yes, the UE further reports the number of models supported in parallel, which model IDs can be parallel supported, and any associated considerations/restrictions for applying a parallel operation of the ML models
   In one example, for inter-cell beam prediction in spatial domain, the beam predictions may use multiple models in parallel, where each model may be a cell-specific model. For each of these cell-specific models, the UE measures beams corresponding to that cell and use the measurements at the input of the model, and the model output provides the best predicted beams of the same cell.
Based on the received UE capability information, the network configures ML model parameters, decide/support model switching, or considers activating more than one model at a given time for given feature-related support towards the UE.

In the following, a specific example of the above-mentioned aspects will be described by considering, as an example, a beam management case (spatial domain beam prediction).

In particular, according to the specific example,
the UE indicates the number of ML models (e.g., X=4, 6, 8) that UE can support for the beam prediction in spatial domain.
the UE indicates a ML model ID (IDs=1, 2, 3, 4 for X=4) and indicates the association between the ML model ID to a parameter list
   Model ID 1-frequency range 2 (FR2), sub-carrier spacing (SCS) 120 kHz, dense urban scenario, base station (BS) antenna config (One panel: (M, N, P, Mg, Ng)=(4, 8, 2, 1, 1), (dV, dH)=(0.5, 0.5) A), Set A dimension (64 beams, layout M1), Set B dimension (4 or 8 or 16 beams, layout N1), Assistance info (NULL), Reportable quantities (Beam ID, L1-RSRP), etc.
   Model ID 2-FR2, SCS 60 kHz, Indoor Hotspot scenario, BS antenna config (One panel: (M, N, P, Mg, Ng)=(2, 2, 2, 1, 1), (dV, dH)=(0.5, 0.5) A), Set A dimension (32 beams, layout M2), Set B dimension (8 or 16 beams, layout N2), Assistance info (beam angles), Reportable quantities (Beam ID), etc.,
the UE indicates that the model can be switched from one to another
   the model switching is dynamic. Multiple combinations (combinations 1, 2, .) and relevant parameters for switching may be provided.
the UE indicates that the model can be disabled, and it is possible to fall back into the parametric model
   associated delay considerations for switching and parameter lists associated with the parametric model may also be indicated by the UE.
the UE indicates that no more than one model can be activated at a given time.
Based on the received UE capability information, the network configures ML model related parameters, decide/support model switching, or considers activating more than one model at a given time for given feature supported towards the UE.

The above-mentioned multiple ML model for same scenario (e.g. use case feature group) can be indicated in the form of the following table:

TABLE 1
Multiple model ID co-existence and switching

| ML | | | Registration | | | |
|---|---|---|---|---|---|---|
| model | Parameter | Data Set ID | ID | Combination | Combination | Combination |
| ID | list | (optional) | (optional) | 1 | 2 | 3 |
| 1 | FR2, SCS | DS_BM_SPA_1 | XYZ | X | X | — |
| | 120 kHz, | | (Vendor | | | |
| | dense | | specific or | | | |
| | urban | | global ID) | | | |
| | scenario | | | | | |
| 2 | FR2, SCS | DS_BM_SPA_2 | XYW | X | — | — |
| | 60 kHz, | | (Vendor | | | |
| | Indoor | | specific or | | | |
| | Hotspot | | global ID) | | | |
| | scenario | | | | | |
| 3 | | DS_BM_SPA_3 | | X | X | — |
| 4 | | DS_BM_SPA_4 | | — | — | X |

The Table 1 discusses how the UE reports the co-existence and switching when using multiple ML models for the same scenario. In the above example, the UE supports four such ML models with the ML model ID 1 to 4 for different parameter lists (optionally providing registration IDs (either a global or vendor specific ID) and the data set ID used for training). The combinations refer to the potential combinations of the ML model that are allowed to operate together. For example, Combination 1 indicates ML model 1 to 3 can operate together (Model ID 4 cannot be configured to the UE in Combination 1) when being configured by the network in a particular band combination for example. Further Table 2 below describes how the Combination should be interpreted by the network for configuration purposes.

TABLE 2
Description of each combination

| | Co-existence | | |
|---|---|---|---|
| Combination ID | requirement | Switching time | Switching method |
| Combination 1 | ML model 1-3 can be | ML model 1 to 2 | Configured by RRC |
| | configured together - | (or 3) | but switching is |
| | activation of models | switching time 2 | using fast L1/L2 |
| | requires different | msec | indication from |
| | switching time | Switching back to | network - e.g., MAC |
| | | ML model 1 4 msec | control channel |
| | | | element |
| Combination 2 | ML model 1 and 3 can be | ML model 1 to 3 | Configured by RRC |
| | configured together - | switching time 4 | but UE decides to |
| | activation of models | msec | switch but informs |
| | requires some switching | | the network |
| | time | | |
| Combination 3 | ML model 4 can be only | Not applicable | Configured by RRC |
| | configured - i.e., single | | only |
| | ML model can be | | |
| | activated at a given time | | |

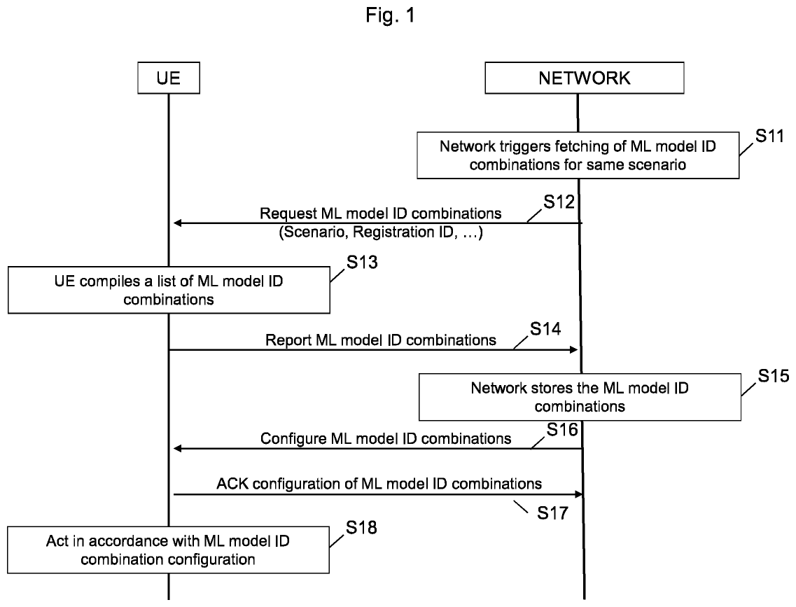

FIG. 1 is a sequence diagram illustrating an example of a signaling procedure according to certain aspects of the present invention.

In step S11 of FIG. 1, the network triggers the fetching of ML model ID combinations for the same scenario (e.g. use case). That is, the network will request the UE to provide information regarding the ML models that are available at the UE for a specific scenario and can be combined.

Therefore, the network sends a corresponding request in step S12 to the user equipment, The request indicates, among others, the scenario for which the available ML models and combinations should be provided. Optionally, it is for example, requested that a registration ID is to be provided by the user equipment.

In step S13, the UE identifies the one or more machine learning model that are available at the user equipment for the predetermined scenario included in the request received in step S12. Then, the user equipment assigns a unique identification to each of the one or more machine learning model. Further, the user equipment associates the one or more machine learning model having the unique identification with at least one of a parameter list, a data set and optionally, the registration ID. That is, the user equipment generates the user equipment capability information and compiles a list of the ML model ID combinations.

Then, in step S14, the user equipment reports the generated user equipment capability information including the available ML models and the combinations to the network.

The network stores the available ML models and the combinations, which are indicated by the ML model ID and configures the ML model ID combinations.

This configuration is then sent to the user equipment in step S16.

The user equipment confirms receipt of the configured ML model ID combinations in step S17 and starts acting in accordance with the configured ML model ID combinations received from the network.

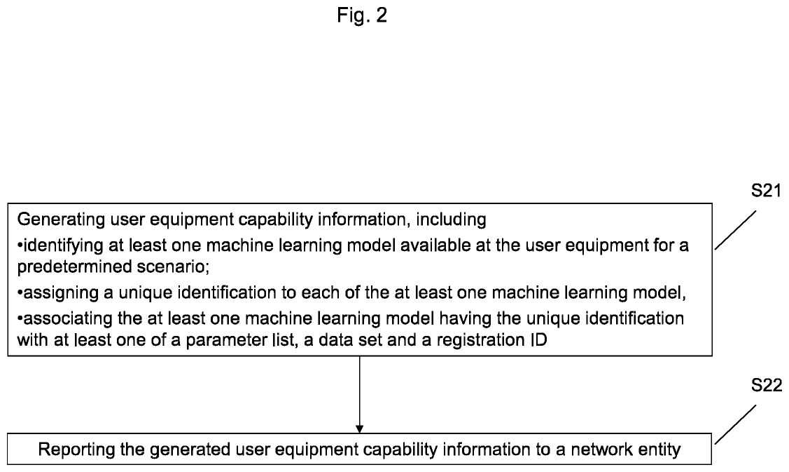

In the following, a more general description of example versions of the present invention is made with respect to FIGS. 2 to 4.

FIG. 2 is a flowchart illustrating an example of a method according to some example versions of the present invention.

According to example versions of the present invention, the method may be implemented in or may be part of a user equipment, or the like. The method comprises generating, in step S21, user equipment capability information.

Generating the user equipment capability information in step S21 includes identifying at least one machine learning model available at the user equipment for a predetermined scenario, assigning a unique identification to each of the at least one machine learning model, associating the at least one machine learning model having the unique identification with at least one of a parameter list, a data set and a registration ID.

Additionally, the method comprises reporting, in a step S22, the generated user equipment capability information to a network entity. The network entity may be a base station, like a gNB.

According to some example versions of the present invention, the method further comprises receiving, from the network entity, a request indicating the predetermined scenario for which the machine learning models are to be identified.

According to some example versions of the present invention, the method further comprises receiving, from the network entity, a configuration regarding the machine learning models to be used for the predetermined scenario based on the reported user equipment capability information, and acting in accordance with the received configuration.

According to some example versions of the present invention, the user equipment capability information includes an indication whether the identified machine learning models can be switched from one to another when being applied for the predetermined scenario.

According to some example versions of the present invention, the user equipment capability information includes an indication whether more than one of the identified machine learning models can be activated at a given time when being applied for the predetermined scenario.

According to some example versions of the present invention, the user equipment capability information includes an indication whether the identified machine learning models can be disabled when being applied for the predetermined scenario to switch to a parametric model.

According to some example versions of the present invention, the parameter list defines at least one of radio conditions inducing at least one of deployment type, applicable scenario, base station/user equipment antenna configurations, and clutter parameters, machine learning specific details including at least one reportable quantities, required measurement configurations, required assistance information, input/output and dimensions of the machine learning model, and restrictions/conditions including at least one inference delay, required warm-up time and fine-tune requirements.

According to some example versions of the present invention, the data set refers to a version of the data set, which is accessible for both the user equipment and network over other means including an operator-controlled server and/or proprietary cloud) and the data set specifies model-related aspects.

According to some example versions of the present invention, the registration ID refers to a unique version of the machine learning model with a unique identifier.

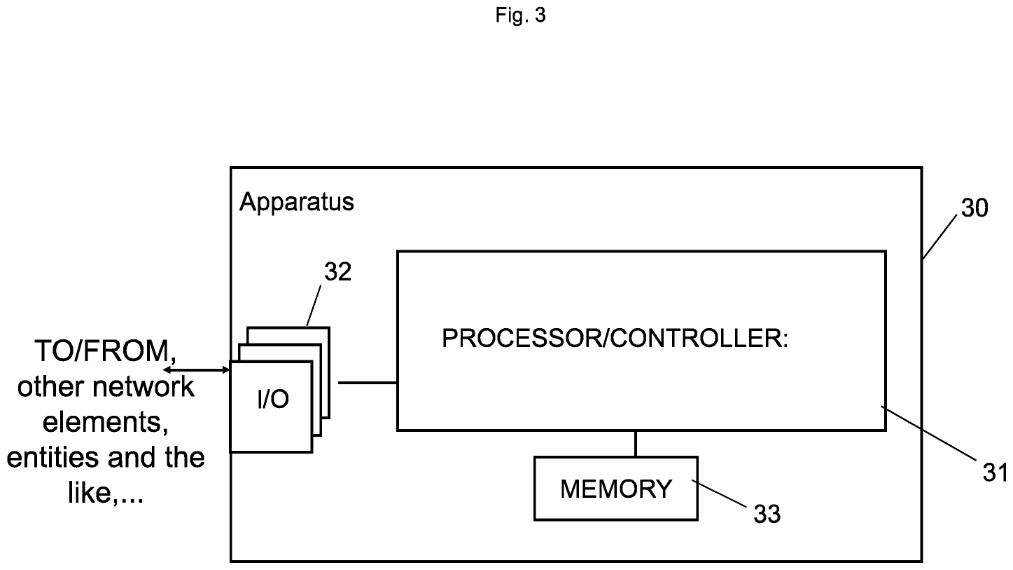

FIG. 3 is a block diagram illustrating another example of an apparatus according to some example versions of the present invention.

In FIG. 3, a block circuit diagram illustrating a configuration of an apparatus 30 is shown, which is configured to implement the above described various aspects of the invention. It is to be noted that the apparatus 30 shown in FIG. 3 may comprise several further elements or functions besides those described herein below, which are omitted herein for the sake of simplicity as they are not essential for understanding the invention. Furthermore, the apparatus may be also another device having a similar function, such as a chipset, a chip, a module etc., which can also be part of an apparatus or attached as a separate element to the apparatus, or the like.

The apparatus 30 may comprise a processing function or processor 31, such as a CPU or the like, which executes instructions given by programs or the like. The processor 31 may comprise one or more processing portions dedicated to specific processing as described below, or the processing may be run in a single processor. Portions for executing such specific processing may be also provided as discrete elements or within one or further processors or processing portions, such as in one physical processor like a CPU or in several physical entities, for example. Reference sign 32 denotes transceiver or input/output (I/O) units (interfaces) connected to the processor 31. The I/O units 32 may be used for communicating with one or more other network elements, entities, terminals or the like. The I/O units 32 may be a combined unit comprising communication equipment towards several network elements, or may comprise a distributed structure with a plurality of different interfaces for different network elements. The apparatus 30 further comprises at least one memory 33 usable, for example, for storing data and programs to be executed by the processor 31 and/or as a working storage of the processor 31.

The processor 31 is configured to execute processing related to the above-described aspects.

In particular, the apparatus 30 may be implemented in or may be part of a user equipment, and may be configured to perform processing as described in connection with FIG. 2.

Thus, according to some example versions of the present invention, there is provided an apparatus 30 for use in a user equipment, comprising at least one processor 31, and at least one memory 33 for storing instructions to be executed by the processor 31, wherein the at least one memory 33 and the instructions are configured to, with the at least one processor 31, cause the apparatus 30 at least to perform generating user equipment capability information, including identifying at least one machine learning model available at the user equipment for a predetermined scenario, assigning a unique identification to each of the at least one machine learning model, associating the at least one machine learning model having the unique identification with at least one of a parameter list, a data set and a registration ID, and reporting the generated user equipment capability information to a network entity.

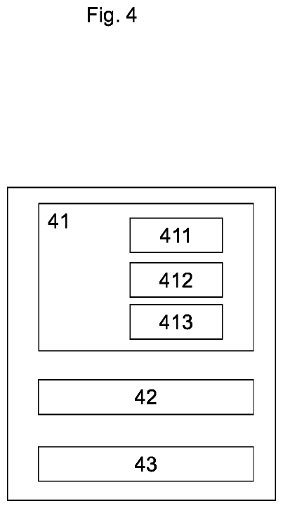

Further, the present invention may be implemented by an apparatus for a user equipment comprising means for preforming the above-described processing, as shown in FIG. 4.

That is, according to some example versions of the present invention, as shown in FIG. 4, the apparatus for use in a user equipment comprises means 41 for generating user equipment capability information. The means 41 for generating includes means 411 for identifying at least one machine learning model available at the user equipment for a predetermined scenario, means 412 for assigning a unique identification to each of the at least one machine learning model, and means 413 for associating the at least one machine learning model having the unique identification with at least one of a parameter list, a data set and a registration ID. Additionally, the apparatus comprises means 42 for reporting the generated user equipment capability information to a network entity.

Additionally, according to some example versions of the present invention, there is provided a computer program comprising instructions, which, when executed by an apparatus for use in a user equipment, cause the apparatus to perform generating user equipment capability information, including identifying at least one machine learning model available at the user equipment for a predetermined scenario, assigning a unique identification to each of the at least one machine learning model, associating the at least one machine learning model having the unique identification with at least one of a parameter list, a data set and a registration ID, and reporting the generated user equipment capability information to a network entity.

The computer program product may comprise code means adapted to produce steps of any of the methods as described above when loaded into the memory of a computer.

According to some example versions of the present invention, there is provided a computer program product as defined above, wherein the computer program product comprises a computer-readable medium on which the software code portions are stored.

According to some example versions of the present invention, there is provided a computer program product as defined above, wherein the program is directly loadable into an internal memory of the processing device/apparatus.

According to some example versions of the present invention, there is provided a computer readable medium storing a computer program as set out above.

According to some example versions of the present invention, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Furthermore, the present invention may be implemented by an apparatus for use in a user equipment comprising respective circuitry for preforming the above-described processing.

That is, according to some example versions of the present invention, there is provided an apparatus for use in a user equipment, comprising a generation circuitry for generating user equipment capability information. The generation circuitry includes identification circuitry for identifying at least one machine learning model available at the user equipment for a predetermined scenario, assignment circuitry for assigning a unique identification to each of the at least one machine learning model, association circuitry for associating the at least one machine learning model having the unique identification with at least one of a parameter list, a data set and a registration ID, and reporting circuitry for reporting the generated user equipment capability information to a network entity.

For further details regarding the functions of the apparatus and the computer program, reference is made to the above description of the method according to some example versions of the present invention, as described in connection with FIG. 2.

In the foregoing exemplary description of the apparatus, only the units/means that are relevant for understanding the principles of the invention have been described using functional blocks. The apparatus may comprise further units/means that are necessary for its respective operation, respectively. However, a description of these units/means is omitted in this specification. The arrangement of the functional blocks of the apparatus is not to be construed to limit the invention, and the functions may be performed by one block or further split into sub-blocks.

When in the foregoing description it is stated that the apparatus (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is to be construed to be equivalent to an expression such as “means for”).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

For the purpose of the present invention as described herein above, it should be noted that
method steps likely to be implemented as software code portions and being run using a processor at an apparatus (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the aspects/embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the aspects/embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components, APU (Accelerated Processor Unit), GPU (Graphics Processor Unit) or DSP (Digital Signal Processor) components;
devices, units or means (e.g. the above-defined apparatuses, or any one of their respective units/means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

It is to be noted that the aspects/embodiments and general and specific examples described above are provided for illustrative purposes only and are in no way intended that the present invention is restricted thereto. Rather, it is the intention that all variations and modifications which fall within the scope of the appended claims are covered.

1. A method for use in a user equipment, comprising:
generating user equipment capability information, including
identifying at least one machine learning model available at the user equipment for a predetermined scenario,
assigning a unique identification to each of the at least one machine learning model,
associating the at least one machine learning model having the unique identification with at least one of a parameter list, a data set and a registration ID, and
reporting the generated user equipment capability information to a network entity.

2. The method according to claim 1, further comprising
receiving, from the network entity, a request indicating the predetermined scenario for which the machine learning models are to be identified.

3. The method according to claim 1, further comprising
receiving, from the network entity, a configuration regarding the machine learning models to be used for the predetermined scenario based on the reported user equipment capability information, and
acting in accordance with the received configuration.

4. The method according to claim 1, wherein
the user equipment capability information includes an indication whether the identified machine learning models can be switched from one to another when being applied for the predetermined scenario.

5. The method according to claim 1, wherein
the user equipment capability information includes an indication whether more than one of the identified machine learning models can be activated at a given time when being applied for the predetermined scenario.

6. The method according to claim 1, wherein
the user equipment capability information includes an indication whether the identified machine learning models can be disabled when being applied for the predetermined scenario to switch to a parametric model.

7. The method according to claim 1, wherein
the parameter list defines at least one of
radio conditions inducing at least one of deployment type, applicable scenario, base station/user equipment antenna configurations, and clutter parameters;
machine learning specific details including at least one reportable quantities, required measurement configurations, required assistance information, input/output and dimensions of the machine learning model; and
restrictions/conditions including at least one inference delay, required warm-up time and fine-tune requirements.

8. The method according to claim 1, wherein
the data set refers to a version of the data set, which is accessible for both the user equipment and network over other means including an operator-controlled server and/or proprietary cloud) and the data set specifies model-related aspects.

9. The method according to claim 1, wherein
the registration ID refers to a unique version of the machine learning model with a unique identifier.

10. An apparatus comprising: at least one processor, and at least one memory storing instructions that, when executed by the at least one processor, cause the apparatus at least to perform:
generating user equipment capability information, including
identifying at least one machine learning model available at the user equipment for a predetermined scenario,
assigning a unique identification to each of the at least one machine learning model,
associating the at least one machine learning model having the unique identification with at least one of a parameter list, a data set and a registration ID, and
reporting the generated user equipment capability information to a network entity.

11. The apparatus according to claim 10, wherein the instructions, when executed by the at least one processor, further cause the apparatus to perform:
receiving, from the network entity, a request indicating the predetermined scenario for which the machine learning models are to be identified.

12. The apparatus according to claim 10, wherein the instructions, when executed by the at least one processor, further cause the apparatus to perform:
receiving, from the network entity, a configuration regarding the machine learning models to be used for the predetermined scenario based on the reported user equipment capability information, and
acting in accordance with the received configuration.

13. The apparatus according to claim 10, wherein
the user equipment capability information includes an indication whether the identified machine learning models can be switched from one to another when being applied for the predetermined scenario.

14. The apparatus according to claim 10, wherein
the user equipment capability information includes an indication whether more than one of the identified machine learning models can be activated at a given time when being applied for the predetermined scenario.

15. The apparatus according to claim 10, wherein
the user equipment capability information includes an indication whether the identified machine learning models can be disabled when being applied for the predetermined scenario to switch to a parametric model.

16. The apparatus according to claim 10, wherein
the parameter list defines at least one of
radio conditions inducing at least one of deployment type, applicable scenario, base station/user equipment antenna configurations, and clutter parameters;
machine learning specific details including at least one reportable quantities, required measurement configurations, required assistance information, input/output and dimensions of the machine learning model; and
restrictions/conditions including at least one inference delay, required warm-up time and fine-tune requirements.

17. The apparatus according to claim 10, wherein
the data set refers to a version of the data set, which is accessible for both the user equipment and network over other means including an operator-controlled server and/or proprietary cloud) and the data set specifies model-related aspects.

18. The apparatus according to claim 10, wherein
the registration ID refers to a unique version of the machine learning model with a unique identifier.

19. A computer program comprising instructions, which, when executed by a user equipment, cause the user equipment to perform:
generating user equipment capability information, including
identifying at least one machine learning model available at the user equipment for a predetermined scenario,
assigning a unique identification to each of the at least one machine learning model,
associating the at least one machine learning model having the unique identification with at least one of a parameter list, a data set and a registration ID, and
reporting the generated user equipment capability information to a network entity.
